(19) United States
(12) Patent Application Publication
(10) Pub. No.: US 2017/0091883 A1
(43) Pub. Date: Mar. 30, 2017

(54) Dynamic Search in Search

(71) Applicant: LF Technology Development Corporation Limited, London (GB)

(72) Inventors: Alexander Greystoke, Lakeway, TX (US); Shy Blick, Austin, TX (US)

(73) Assignee: LF Technology Development Corporation Limited, London (GB)

(21) Appl. No.: 15/230,349

(22) Filed: Aug. 5, 2016

Related U.S. Application Data
(63) Continuation-in-part of application No. 14/793,618, filed on Jul. 7, 2015.
Application No. 14/793,618 is a continuation-in-part of application No. 14/327,543, filed on Jul. 9, 2014.
Application No. 14/327,543 is a continuation-in-part of application No. 14/169,058, filed on Jan. 30, 2014.
Application No. 14/169,058 is a continuation-in-part of application No. 14/169,060, filed on Jan. 30, 2014.
Application No. 14/169,060 is a continuation-in-part of application No. 14/603,227, filed on Jan. 22, 2015.
Application No. 14/603,227 is a continuation-in-part of application No. 14/640,865, filed on Mar. 6, 2015.
Application No. 14/640,865 is a continuation-in-part of application No. 14/738,881, filed on Jun. 13, 2015.
(60) Provisional application No. 62/201,572, filed on Aug. 5, 2015.
(60) Provisional application No. 61/759,314, filed on Jan. 31, 2013.
(60) Provisional application No. 61/759,317, filed on Jan. 31, 2013.
(60) Provisional application No. 61/844,355, filed on Jul. 9, 2013.
(60) Provisional application No. 61/844,353, filed on Jul. 9, 2013.
(60) Provisional application No. 62/011,574, filed on Jun. 13, 2014.

(51) Int. Cl. G06Q 50/14; G06Q 10/02; G06Q 30/06

(52) U.S. Cl. CPC G06Q 50/14; G06Q 30/0623; G06Q 30/0641; G06Q 10/02

(57) ABSTRACT

In certain embodiments, a purchase option system may include an interface configured to couple to a network, a processor coupled to the interface, and a memory coupled to the processor. The memory may be configured to store instructions that, when executed, cause the processor to provide a graphical interface to a destination device via the interface. The graphical interface can include at least one purchase option of a plurality of purchase options and can include a plurality of selectable options corresponding to each adjustable variable within the plurality of purchase options. The memory may further include instructions that, when executed, cause the processor to receive data corresponding to selection of one of the plurality of selectable options and provide an update to the graphical interface to include at least one different purchase option determined from the plurality of purchase options based on the received data.

### CROSS-REFERENCE TO RELATED APPLICATION(S)

The present application is a non-provisional of and claims priority to U.S. Provisional Application No. 62/201,572 filed on Aug. 5, 2015 and entitled “Dynamic Search in Search”, which is incorporated herein by reference in its entirety. Further, the present application is a continuation-in-part of and claims priority to U.S. patent application Ser. No. 14/793,618, filed on Jul. 7, 2015 and entitled “Systems and Methods of Providing Outcomes Based on Collective Intelligence Experience”, which is a continuation-in-part of and claims priority to U.S. patent application Ser. No. 14/327,543, filed on Jul. 9, 2014, and entitled “Computer-Aided Decision Systems,” which is a continuation-in-part of and claims priority to U.S. patent application Ser. No. 14/169,058, filed on Jan. 20, 2014, entitled “VIRTUAL PURCHASING ASSISTANT”, which claimed priority to U.S. Provisional Patent Application No. 61/759,314, filed on Jan. 21, 2013, and entitled “VIRTUAL PURCHASING ASSISTANT”; and is also a continuation-in-part of and claims priority to U.S. patent application Ser. No. 14/169,060 filed on Jan. 20, 2014, entitled “DUAL PUSH SALES OF TIME SENSITIVE INVENTORY”, which claimed priority to U.S. Provisional Patent Application No. 61/759,317, filed on Jan. 21, 2013, and entitled “DUAL PUSH SALES OF TIME SENSITIVE INVENTORY”; and is also a non-provisional of and claims priority to U.S. Provisional Patent Application No. 61/844,355, filed on Jul. 9, 2013, entitled “INVENTORY SEARCHING WITH AN INTELLIGENT RECOMMENDATION ENGINE”; is also a non-provisional of and claims priority to U.S. Provisional Patent Application No. 61/844,353, filed on Jul. 9, 2013, entitled “SINGLE PAGE TRAVEL SEARCH AND RESULTS MODIFICATION”; and is also a non-provisional of and claims priority to U.S. Provisional Patent Application No. 61/844,350, filed on Jul. 9, 2013, entitled “SEARCHING FOR INVENTORY USING AN ARTIFICIAL INTELLIGENCE PRIORITIZATION ENGINE”; and is also a continuation-in-part of and claims priority to U.S. patent application Ser. No. 14/603,227 filed on Jan. 22, 2015, entitled “INTELLIGENT PROPERTY RENTAL SYSTEM”; and is also a continuation-in-part of and claims priority to U.S. patent application Ser. No. 14/640,865 filed on Mar. 6, 2015, entitled “PURCHASING FEEDBACK SYSTEM”; and is also a continuation-in-part of and claims priority to U.S. patent application Ser. No. 14/738,881 filed on Jun. 13, 2015, entitled “SYSTEMS AND METHODS FOR A LEARNING DECISION SYSTEM WITH A GRAPHICAL SEARCH INTERFACE”; and is also a non-provisional of and claims priority to U.S. Provisional Patent Application No. 62/011,574, filed on Jun. 13, 2014, entitled “PERSONA-BASED PURCHASING ASSISTANTS”, the contents of all of which are hereby incorporated by reference in their entireties.

### FIELD

The present disclosure is generally related to the field of computerized systems for identifying, reviewing, and optionally selecting products and services for purchase or referral. More particularly, the present disclosure generally relates to computerized systems and methods that use augmented intelligence to identify products or services on behalf of a user and that allow the user to dynamically adjust selected variables of the selected products and services to refine the results without having to restart the search for the product.

### BACKGROUND

Many computerized systems exist that may allow a user to search for various products and services, to review the search results, and to select one or more options. In the context of travel, for instance, a traveler, a travel agent, or an assistant can search, review, and book travel options. In such systems, the user may often filter existing search results based on one or more parameters; however, the filtered search results reduce the subset of the results, but are limited to the search terms entered by the user. Further, to adjust dates, times, departure or arrival cities or airports, class of service, or other variables, the system may have to conduct a separate search.

### SUMMARY

In certain embodiments, a purchase option system may include an interface configured to couple to a network, a processor coupled to the interface, and a memory coupled to the processor. The memory may be configured to store instructions that, when executed, cause the processor to provide a graphical interface to a destination device via the interface. The graphical interface can include at least one purchase option of a plurality of purchase options and including a plurality of selectable options corresponding to each adjustable variable within the plurality of purchase options. The memory may further include instructions that, when executed, cause the processor to receive data corresponding to selection of one of the plurality of selectable options and provide an update to the graphical interface to include at least one different purchase option based on the received data.

In certain aspects, the plurality of purchase options may include travel itineraries including a first travel itinerary and a second travel itinerary. In certain embodiments, the first travel itinerary and the second travel itinerary may initially share a common departure city and a common destination city. The memory may further include instructions that, when executed, cause the processor to receive data corresponding to selection of one of the plurality of selectable options indicating a change to an attribute of the search that may impact the travel itineraries displayed to the user. In response to the change, the processor may update the first travel itinerary based on the change without altering the second travel itinerary within the graphical interface. Alternatively, the processor may replace the first and second travel itineraries with different travel itineraries corresponding to the change and without restarting the search.

In other embodiments, a method may include providing a graphical interface to a destination device through a network. The graphical interface can include one or more purchase options of a plurality of purchase options from a plurality of data sources. The graphical interface may include a plurality of selectable elements, and each selectable element may correspond to a variable associated with the plurality of purchase options. The method may further include receiving data corresponding to selection of one of the at least one selectable elements, determining a different purchase option from the plurality of purchase options without initiating a new search in response to receiving the data, and providing the different purchase option to the graphical interface.

### BRIEF DESCRIPTION OF THE DRAWINGS

FIG. 1 depicts a block diagram of a purchase option system including dynamic itinerary adjustment, in accordance with certain embodiments of the present disclosure.

FIG. 2 illustrates a block diagram of a purchase option system including dynamic itinerary adjustment, in accordance with certain embodiments of the present disclosure.

FIG. 3 depicts a conceptual diagram of a mapping of a decision tree representing a plurality of outcomes determined by a purchase option system, in accordance with certain embodiments of the present disclosure.

FIG. 4 illustrates a block diagram of an interface of a purchase option system including dynamic itinerary adjustment, in accordance with certain embodiments of the present disclosure.

FIGS. 5A-5C depict block diagrams of an interface of a purchase option system including dynamic itinerary adjustment, in accordance with certain embodiments of the present disclosure.

FIG. 6 illustrates a diagram of an interface of a purchase option system including dynamic itinerary adjustment, in accordance with certain embodiments of the present disclosure.

FIG. 7 depicts a graphical interface of potential outcomes provided by a purchase option system, in accordance with certain embodiments of the present disclosure.

FIG. 8 depicts a second graphical interface of potential outcomes provided by a purchase option system, in accordance with certain embodiments of the present disclosure.

FIG. 9 illustrates a flow diagram of a method of providing dynamic itinerary adjustment, in accordance with certain embodiments of the present disclosure.

FIG. 10 depicts a flow diagram of a method of providing dynamic itinerary adjustment, in accordance with certain embodiments of the present disclosure.

FIG. 11 illustrates a flow diagram of a method of providing dynamic adjustments, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of the embodiments, reference is made to the accompanying drawings which form a part hereof, and which are shown by way of examples. The features of the various embodiments and examples described herein may be combined, exchanged, removed, have other embodiments utilized, and structural changes made without departing from the scope of the present disclosure.

One or more aspects or features of the subject matter described herein can be implemented in digital electronic circuitry, integrated circuitry, application specific integrated circuits (ASICs), field programmable gate arrays (FPGAs), another dedicated hardware implementation, computer hardware, firmware, software, or any combination thereof. In accordance with various embodiments, the methods and functions described herein may be implemented as one or more software programs executable by a computer processor of a computing device, such as a laptop computer, a server, a desktop computer, or a handheld computing device, such as a tablet computer, a personal digital assistant (PDA), or smart phone. Further, in some embodiments, the methods and functions described herein may be implemented as a device, such as a non-volatile computer readable storage device or memory device, including instructions that, when executed, cause a processor to perform the methods and functions. As used herein, a digital persona, such as a persona in the digital personas 138, can be a digital representation of an entity (a human, corporation, group, etc.). A digital persona can be a digital representation of a virtual being or a real being that has a set of preferences or rules in relation to a certain problem. An entity may be a depiction of a virtual or real being that has a set of preferences, weights or tendencies in relation to a certain problem. A potential solution may be a solution to a problem that may or may not relate to the priorities of a corresponding digital persona. In certain embodiments, a potential solution may represent a potential option that may be selected to satisfy one or more of the digital persona's needs or solve their problem. A chosen or selected solution can be at least one of the potential solutions that, by way of weighing, was chosen to be appropriate (or most appropriate) to solve the problem or that was determined, based on scoring, to be the most satisfactory to the digital persona.

An engine can be a software mechanism that can process several tasks: such as reading digital persona preferences; obtaining a list of potential solutions; combining competing personas into a unified persona; selecting between competing personas to identify a subset of possible solutions; and determining optimal solutions with respect to specific situations. Priority can be a way to show a preference in relation to other preferences so as to allow the engine to weigh an impact of a preference on the overall score. An entity may be a human, corporation, or group that may have preferences with respect to a certain problem, a set of products, a scenario, a situation, or any combination thereof. An entity may either be virtual or real. The entity may represent a virtual entity, a person, a certain facet of a person (e.g., the user as a business person vs. the user as a family person), or a surrogate (e.g., an entity acting on behalf of an employer, a parent for a child, a guardian in a custodial relationship, or a trustee on behalf of a beneficiary). A parameter may be a specific set of rules, preferences, and priorities established by a user of a digital persona with respect to a defined situation or opportunity to decide among varied options. The context of the decision-making may alter how the user makes decisions. The system may include multiple personas for a particular user, where each persona represents the user's decision making in a particular context or role. Initially, the system may determine (based on user interactions), which role best represents the user's decision-making, and may configure an artificial intelligence engine based on the selected persona and process the search results to compare them using the configured artificial intelligence engine.

Embodiments of a computing system may be configured to capture a snapshot of available purchase options and to process each purchase option into a plurality of linked attributes. In some embodiments, at least a portion of the snapshot of available purchase options may be captured in response to a search request.

When a search is initiated by a user, the system may determine a set of the available purchase options that correspond to the information provided by the user and may provide an interface including at least some available purchase options that satisfy the criteria provided by the user. The interface may also include one or more user-selectable options corresponding to attributes of the snapshot of available purchase options. In response to user selection or adjustment of one or more of the selectable options, the system may determine a second set of the available purchase options corresponding to the user selection. Further, in some embodiments, the system may include a recommendation of a change to one of the attributes that may result in “better” purchase options.

In some embodiments, the user-selectable options may include a rotating wheel or a pull-down menu listing available attributes for the particular search. The system may default to a subset of the available attribute options that are commonly available, and may provide an option for the user to add additional attributes to the search options to refine the search. For example, in the context of travel, such options may include options that are commonly available (such as departure date, departure time, and so on), and the system may allow the user to add other attributes for search/selection that are not typically searchable (such as seat width, leg room, age of the plane, when the inside of the plane was refurbished, WIFI availability, individual viewing screens, and so on). The system may determine the various attributes automatically from available information to determine what information can be searched, and the selectable options may expose the searchable information to the user, making it possible for the user to search on attributes that he or she did not even know were possible.

Embodiments of a computing system may be configured to allow a user to review a set of potential purchase options (such as travel services, travel products (e.g., hotels, car rentals, travel packages, or other product or service options, etc.), automobiles for purchase or lease, electronic devices, or other products or services, or any combination thereof) and to selectively configure one or more variables. After the initial search is performed, the user may continue to adjust the one or more variables within the search, and the system may automatically update an interface with purchase options reflecting the adjusted variables. The updated purchase options may be selected from a snapshot of available purchase options and without conducting a new search.

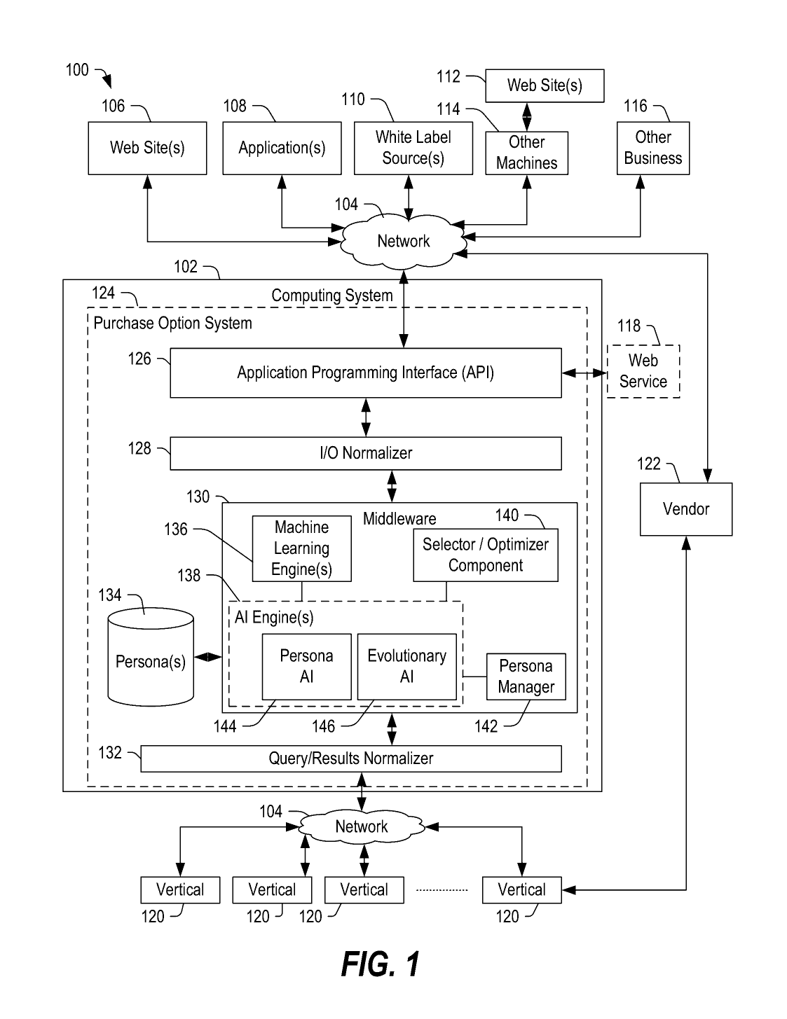

In the context of travel, a travel system may provide an interface including data related to the potential travel product and user-selectable elements accessible by a user to alter any one of a plurality of variables to adjust the data. The data related to the potential travel products may be selected from a set of search results including a snapshot of available inventory (some related and some seemingly unrelated to a user's initial query). In an example, the user may access one of the plurality of user-selectable elements to insert a destination between a departure location and a destination location (such as between a departure airport and a destination airport). In response to input corresponding to one of the user-selectable elements, the travel system may review the snapshot of the available travel inventory to identify potential outcomes corresponding to the input and may update the potential travel itineraries based on the identified potential outcomes. Further, the user may add one or more selectable options determined from the attributes of the snapshot of available inventory and may configure the selected one or more selectable options to adjust the potential attributes provided within the interface. Additionally, in some embodiments, the travel system may automatically identify and stitch together travel segments involving different suppliers, different modes of travel, and so on to provide a potential outcome corresponding to the user's objectives. One possible example of a purchase option system is described below with respect to FIG. 1.

FIG. 1 is a block diagram of a system 100 including a purchase option system 124, in accordance with certain embodiments of the present disclosure. The system 100 may include a computing system 102 that can be configured to communicate through a network 104 with websites 106, applications 108 (including mobile applications), white label sources 110 (i.e., private label applications or services), other machines 114, one or more websites 112 through one of the other machines 114, other businesses 116, vendors 122, or any combination thereof. Additionally, the computing system 102 may be coupled to one or more verticals 120 through the network 104. The term “vertical” may refer to a particular market sector, such as travel, financial, healthcare, real estate, entertainment, education, military, retail, grocery and produce, employment, etc. Each of the verticals, identified by 120, may include a plurality of websites, businesses, etc. that service that particular sector. One vertical 120, for example, may include travel options and services. Another vertical 120 may correspond to electronic device suppliers. Still another vertical 120 can include rental properties. Still another vertical 120 can include automobile suppliers, and so on. Though each of the verticals 120 is depicted as distinct, it should be understood that the verticals 120 can overlap one another and that a business entity or website may cross multiple verticals, or sub-categories within one or more verticals (sub-verticals).

The computing system 102 can include a purchase option system 124. The purchase option system 124 may include an application programming interface (API) 126, which may communicate with the websites 106, applications 108, white label sources 110, other machines 114, other businesses 116, web services 118, vendors 122, or any combination thereof. In an example, the API 126 may provide web services 118, such as serving Internet-accessible web pages and associated data to requesting devices or systems and may communicate data to devices or systems that may provide the data in a hosted interface, such as an application interface, a web browser interface, or another type of interface. The web services 118 may be part of the API 126 of the computing system 102 or may be associated with another device or system. The API 126 may coordinate interactions between the computing system 102 and external components, devices, applications, etc. Further, the API 126 may receive data from the network 104 and may provide the data to an input/output (I/O) normalizer 128.

The I/O normalizer 128 can translate received data into a format suitable for processing by middleware 130. In certain embodiments, the I/O normalizer 128 may extract, transform, and load (ETL) received data using an artificial intelligence engine, a machine learning module, previously defined ETL rules, or any combination thereof. In particular, the I/O normalizer 128 may extract data from a received data stream, transform the data into one or more appropriate formats (e.g., transform date information in a form of m/d/yy into a form mm/dd/yyyy; identify textual content to classify the text for loading, and so on), and load the data into a temporary table, which may be provided to the middleware 130. In certain embodiments, the I/O normalizer 128 may be a circuit configured to automatically format the data into a table or other temporary storage.

The middleware 130 may include one or more machine learning engines 136, which may be configured to observe interactions between a device (such as a user's computer or smart phone, an application, another machine, a vendor, and so on) and the computing system 102. The machine learning engines 136 may process metadata about such interactions, process decision-making, and make suggestions to one or more AI engines 138. In certain embodiments, the machine learning engines 236 may attempt to predict decision-making by a particular user based on available options and may learn from differences between the actual interactions and the predicted interactions. Over time, the machine learning engines 136 may become better at predicting decision-making and may adapt their decision-making to improve their predictions for each user.

In some embodiments, the middleware 130 may include one or more artificial intelligence (AI) engines 138, including a persona AI 144 and an evolutionary AI 146. The one or more AI engines 138 may be configured, using personas selected from a plurality of personas 134, to substantially match preferences, habits, and decision-making characteristics of one or more consumers. Each persona may represent a digital presence or avatar that corresponds to and represents the digital decision-making of a particular entity (such as a user) within a particular context and given options available at a particular point in time. In some embodiments, the AI engine 138 may be configured according to a selected persona to perform decision-making on behalf of the user. In some embodiments, the AI engines 138 may be configured with multiple personas corresponding to different aspects of a decision-maker's personality or reflecting different roles that the decision maker may play at different times. The configured AI engines 138 may identify outcomes on behalf of the user and may prioritize identified outcomes according to the particular persona.

The middleware 130 may also include a persona manager 142 configured to select one or more personas from the plurality of personas 134 and to configure the persona AI 144 based on the selected personas. Over time, decisions may be made by a user that correspond to or that differ from priorities indicated by the selected personas. The evolutionary AI 146 may process such decisions and may adjust the parameters of one or more of the personas based on such information, allowing personas to evolve, learn, improve, and become more accurate and more closely aligned with a user's intent and preferences over time. In some embodiments, the evolutionary AI 146 may initiate changes in selected personas based on user interactions with the data, based on information derived from other personas, based on information derived from the “universe” of options, or any combination thereof. The adjusted persona may be stored in memory with the plurality of personas 134.

In some embodiments, the purchase option system 124 may include a query/results normalizer 132, which may be configured to receive one or more queries and to process the one or more queries into a format suitable for searching one or more data sources. In some embodiments, the queries may be generated automatically by the AI engines 138 based on data received from a user or from another source. The AI engines 138 may generate queries based on the request received from a user, based on collective information, or any combination thereof. In some embodiments, the API 126 may cooperate with the query/results normalizer 132 to generate the query in a proper format for each of a plurality of potential suppliers. The queries may then be sent to one or more suppliers via the network 104. In some embodiments, at least one of the queries may be directed to a database including aggregated vendor data, which may have been collected, normalized, and stored using web spiders or bots configured to automatically traverse websites and to retrieve data. In some embodiments, the query/results normalizer 132 may be configured to receive results in response to a query or from a variety of sources and may be configured to extract, transform, and load data from the results into a pre-determined format, such as a table having predetermined fields such that the data is in a format suitable for processing using the configured AI engines 138.

In certain embodiments, the API 126 may communicate with an interface, such as a web page, to a computing device via the website 106, for example, or via an application 108, such as an application configured to run on a smart phone, a tablet computer, or other computing device. The API 126 may receive input data in response to the interface, such as user selections, user requests, and the like. The API 126 may communicate the data to the I/O normalizer 128.

The I/O normalizer 128 may process the received data. In certain embodiments, the I/O normalizer 128 may extract, transform, and load the received data into a pre-defined format, such as a table or other data structure. The I/O normalizer 128 may provide normalized data to the middleware 130. In certain embodiments, the normalized data may include an indicator corresponding to a particular user or a particular user device.

The persona manager 142 may determine one or more personas from the personas 134 in response to the normalized data or in response to data about the user or user device. The persona manager 142 may configure the persona AI engine 144 according to selected personas. The persona AI engine 144 may produce one or more queries to identify potential outcomes corresponding to the data provided by the consumer and may provide the one or more queries to the query/results normalizer 132, which may normalize a query, data, other information, or any combination thereof into data formatted for a particular one of the verticals 120.

In some embodiments, the query/results normalizer 132 may wrap each query with a “wrapper” that configures the query for a particular data source. In some embodiments, the computing system 102 may have a “wrapper” for each data source, indicating the format and attribute selections used for interacting with a particular data source (such as a vendor 122 or one or more data sources within a selected vertical 120). Each “wrapper” may include an instruction set that can be selected to “wrapper” the query for a particular data source. By “wrappering” a query, the query/results normalizer 132 may configure the query to search a data source associated with each supplier based on a supplier-specific set of instructions or rules. The query/results normalizer 132 may apply the wrapper both to format the query for a particular supplier and to direct the system 102 to conduct the search via a particular supplier (i.e. where to send the data, how to send the data, etc.). The query/results normalizer 132 may receive results from each supplier in response to the query and may process the results according to the supplier-specific instructions, extracting, processing, and loading the results into a temporary table of search results. Thus, the query/results normalizer 132 may process the query into formats suitable for each supplier of the particular vertical 120. In some embodiments, one or both of the API 126 and the I/O normalizer 128 may utilize collective information to identify “better” or “best” searches, which may yield better outcomes.

The middleware 130 may also use one or more personas to impact the searches. In an example, the middleware 130 may select one or more personas from personas 134 using the persona manager 142. The middleware 130 may also apply the selected persona(s) to the query using the persona AI engine 144 to perform query expansion, apply modifications or corrections to the query, and add constraints and refinements to the queries according to a selected persona to customize the query to the selected persona. The middleware 130 may provide the processed query to the query/results normalizer 132, which may format the processed query for a particular vertical 120. The query/results normalizer 132 may then provide the wrapped query to one or more data sources associated with the vertical 120.

In certain embodiments, the selected digital personas may be applied to the persona AI engine 144 to process the input data to adjust keywords, apply restrictions and query enhancements, and produce queries that are aligned with the specific preferences and restrictions associated with that particular persona. Such preferences and restrictions may be configured by a user, may be learned over time from explicit and implicit feedback from the user's interactions, may be inferred from interactions of various personas, or any combination thereof. The queries produced by the persona AI engine 144 based on each of the selected personas may be normalized by query/result normalizer 132 and may be sent to one or more data sources.

In response to sending the processed and normalized queries to one or more data sources, the computing system 102 may receive results associated with one or more products or services (e.g., purchase options) in the particular vertical. The query/results normalizer 132 may receive results from multiple data sources and may extract, transform, and load the results into one or more temporary tables, which may be passed to the middleware 130. The persona AI engine 144 may apply one or more selected personas from personas 134 to the results to produce one or more processed results. The processed results may be ranked, sorted, weighed, filtered, processed, or any combination thereof according to each of the one or more selected personas, potentially producing multiple multi-dimensional sets of processed results, which may be provided to the selector/optimizer component 140.

In some embodiments, a user may search for a particular purchase option by interacting with a website 106. The user may submit the search to the computing system 102, which may utilize the middleware 130 to generalize the search to retrieve a snapshot of the available inventory by querying a plurality of data sources. In some instances, the snapshot of available inventory may include options that are unrelated to the user's initial search. The machine learning engine 136 (in conjunction with the AI engines 138) may parse the received results into a plurality of linked trees, where each branch corresponds to an attribute within a hierarchy of attributes for a particular purchase option. The AI engine 138 can be configured with one or more personas 134, and the AI engine 138 may identify purchase options within the forest of linked trees that correspond to the user's search options, rank the identified purchase options based on the particular persona's preferences, and provide data related to at least some of the identified purchase options by providing a graphical interface including the data and including one or more selectable options corresponding to the attributes. The user may interact with one or more of the selectable options of the search, causing the data presented within the graphical interface to change to reflect the selectable options according to the user interactions.

In an example, the user may initiate a search for a television, such as by typing a natural language search. The system may present a subset of available purchase options within a graphical user interface and may include a plurality of user-selectable options, such as a new/used option, an LED/LCD option, a resolution option, a size option, and so on. Additionally, non-standard attributes may also be selected by the user, such as the speaker manufacturer, the curvature of the view area, the size of the border, and so on. The user may select and add one or more of the non-standard attributes. User selection or adjustment of any of the attributes may cause the graphical interface to display a different subset of the available purchase options, without performing a new search. Rather, the AI engine 138 may identify one or more linked trees within the forest of linked trees that satisfy the adjusted attributes to determine the different subset of the available purchase options. The AI engine 138 may also initiate an additional search via the query/results normalizer 132 to identify potential purchase options that may have become available since the previous search. Such results may be processed and added to the forest of linked trees. The searches may continuous continuously, and identified purchase options may be added to the forest of linked trees, and the user may interact with the various options to see the impact of various changes on the available options.

In some embodiments, the AI engines 138 may be configured to provide recommendations to assist the user in configuring the options. In an example, based on yield management rules determined over time and based on available options, the AI engines 138 may provide a popup or other indicator through which improvements or the impact of certain adjustments may be explained to the user. Other embodiments are also possible.

In some embodiments, the middleware 130 can deliver specific facts and circumstances to a persona AI engine 144 with selected digital personas from the personas 134, where each of these selected digital personas offers a potential solution in accordance with the following process: (1) the middleware 130 can produce a solution aligned with specific preferences and restrictions pre-established by the user within each digital persona; (2) the selector/optimizer component 140 can conduct a competition among the outcomes determined from selected digital personas to determine optimal outcomes for the user in the context of the specific facts and circumstances of each user request; and (3) the selector/optimizer component 140 can resolve the multiple potential outcomes presented by the user of the digital persona to produce a set of outcomes.

The purchase option system 124 may receive results corresponding to each of the normalized queries, and the results from each of the queries provides a basis for competition among the digital personas, which competition may be resolved by the selector/optimizer component 140 to determine optimal outcomes for the particular problem. The results may be normalized by query/result normalizer 132 and provided (together with the associated persona) to the selector/optimizer component 140, which may select between the results or which may selectively combine the results from one or more of the sets of results to produce a plurality of potential outcomes. In some embodiments, the selector/optimizer 140 can process the potential outcomes to determine the “better” or “best” outcomes and can provide the selected outcomes to the I/O normalizer 128, which may extract, transform, and load the data from the selected one of the sets of processed results into a format suitable for the API 126 to provide the results to a destination, which may be a device, an application, a web interface, etc. As discussed above, the machine learning engines 136 and the AI engines 138 may cooperate to extract attributes from the various purchase options, assemble each purchase option into a linked tree and add the linked tree to the forest of link trees. The forest of linked trees may represent a snapshot of available purchase options.

In some embodiments, the AI engines 138 may utilize collective information to determine outcomes that may be more valuable to the user than other options. In some embodiments, where rules apply, the purchase option system 124 may apply yield management rules and experiential information to identify options that may not otherwise have been identified in the user's search, but which may be valuable to the user. In the context of travel, the AI engines 138 may recognize that one way travel options may be cheaper than a roundtrip alternative, or that a Tuesday departure may be cheaper than a Thursday departure. Further, the AI engines 138 may also recognize that a Saturday night stay may be a better alternative than returning on a Thursday night. Accordingly, applying those rules, the AI engines 138 may identify two one-way travel options or may identify a “better” or cheaper travel option requiring a stay over, with a Saturday night stay, or leaving on a Tuesday rather than a Thursday. The purchase option system 124 may develop experience with yield management rules as well as routine price variations over time (based on real-world sense checking, adding search variations, etc.), and may determine that such variations can provide better results based on the yield management rules. The AI engines 138 can make use of such information to perform “better” searches that can yield “better” outcomes. Further, the AI engines 138 may learn from experts, from results of other searches, and so on, and such learning may be applied in making recommendations or in conducting the searches.

Embodiments of the purchase option system 124 may be configured to identify potential outcomes and to provide selected ones of the potential outcomes within an interface, which may be rendered as a web page or application interface on a computing device. Further, even after one or more of the potential outcomes have been purchased, the purchase option system 124 may continuously search for “better” options, and may provide information related to the “better” options to the user.

In certain embodiments, when the purchase option system 124 identifies a purchase option that saves the user money, the purchase option system 124 may hold the purchase option and notify the user to determine if he or she wants the purchase option system 124 to complete the transaction. Other options are also possible.

In certain embodiments, the API 126 may cooperate with the middleware 130 to provide dynamic search-in-search functionality. In certain embodiments, the API 126 may provide an interface including purchase option data corresponding to a user's request, such as a travel itinerary and associated cost. The API 126 may show other options and recommended itinerary changes that might yield a better outcome for the user.

Further, the interface may include user-selectable options, such as wheels, pull-down menus, or other user-selectable elements that allow the user to adjust one or more attributes. In certain embodiments, the user may interact with one or more user-selectable options within the interface to expand or alter his/her potential outcomes based on any of a plurality of variables or attributes (and variables-from-variables), which may change and extend with each interaction with the interface. In some embodiments, the user may add one or more attribute selection options to the navigation interface (such as by dragging and dropping an option, selecting an option from a menu, and so on). The added attribute selection option may be configured by the user to adjust the results. In a travel context, the user might add an additional stop, may add a seat-size search attribute, and so on. The addition of the attribute selection may alter purchase options depicted within the graphical interface and may cause the AI engines 138 to reorder the search results and to identify a different subset of the search results.

In certain embodiments, the user may select a purchase option to save to his or her clipboard. The user may pin or otherwise save selected purchase options for subsequent review. Purchase options from multiple different searches or different options from the same search may be saved to the clipboard. In some embodiments, the AI engines 138 may be configured to process the saved purchase options and to provide a recommendation between the saved options. In some embodiments, the AI engines 138 may also be configured to identify other potential options that are similar to the saved options and that may be of greater value to the user. In an example, the AI engines 138 may analyze the saved options to determine their attributes and may determine other potential options from the snapshot of available options that correspond to the identified attributes. Other embodiments are also possible.

In certain embodiments involving travel, the user may interact with the interface to insert additional (intervening) destinations in a direct flight or in a multi-stop trip. Each departure time and each airport may become a variable, which may impact corresponding variables on either side. Thus, without restarting the search, the user may interact with the interface to change departure and arrival cities along with subsequent stops and their times. Such changes propagate through the itinerary, and the purchase option system 124 may process potential outcomes to identify a potential outcome that meets the newly established criteria. Such changes may allow the user to switch between airlines from stop-to-stop, making the itinerary dynamic in order to fit the user's specifications, within the constraints provided by the available options, and including identifying alternatives that may be outside of the box, such as adjusting departure cities and traveling by different modes of transportation (e.g., plane, train, automobile, and boat).

In some embodiments, the AI engines 138 may utilize information about the user's contacts, friends determined from social media (e.g., Facebook® or other social media sites), bucket list data, or other input information to determine locations of friends that the user may want to visit. The AI engine 138 may identify a potential stopover that would enable the user to see an old friend or to conduct a business meeting with a business associate. The system may recommend a different combination of flight segments, for example, that may allow the user to meet with the contact, adding value for the user. Other options are also possible.

In certain embodiments, the AI engines 138, the machine learning engines 136, or both may include artificial neural networks (ANNs), which may be used to estimate or approximate functions that can depend on a large number of inputs and are generally unknown. The ANN may be presented as one or more systems of interconnected “neurons”, which may be configured to send messages to each other. The connections may be assigned numeric weights that can be tuned based on experience (through training and prediction), making the ANN adaptive to inputs and capable of learning, improving, and becoming more accurate and more closely aligned with the user's intent and preferences over time. In certain embodiments, the ANN may be part of the AI engines 138, which can include both non-adaptive elements (persona AI engines 144) and adaptive elements (evolutionary AI engines 146). In certain embodiments, the AI engines 138 may utilize a network function (f(x)) to determine potential outcomes. Each outcome may be defined as a composition of a plurality of nested functions, each of which may be associated with a particular variable with respect to the available inventory at any given point in time. The inventory may include products, services, information, or any combination thereof. The variables may be partially dependent on the context and may be partially independent from one another.

In certain embodiments, the AI engines 138 may be configured to solve a class of functions that solve a task in some sense. The task may include travel to a destination, purchase of a service or a product, locating information for a specific purposes, or any combination thereof. The AI engines 138 may define a cost function to determine a value of each possible solution in terms of a selected parameter, such as price, duration, true value, and so on. The machine learning engine 136 and the AI engines 138 may process inventory data and search for inventory that may have a cost function that has the smallest possible cost over the sample space that satisfies constraints associated with the particular task.

In certain embodiments, the computing system 102 may define an ad hoc cost function having properties determined to be desirable based on the selected persona. Some cost functions may naturally arise from a particular formulation of the data request (e.g., “lowest priced flight from Austin, Tex. to London, England departing on June 1”). Ultimately, the cost function will depend on the desired task. Further, the cost function may be influenced by timing, destination airport, departure airport, availability, and various other factors. By interacting with the user-selectable options, the user may experiment with a variety of changes to view the impact on cost (or other factors) and without having to re-perform the search. In certain embodiments, adjustment of a single attribute or variable may impact multiple factors. For example, in the context of an airline flight, selecting a seat width attribute may eliminate some flights, impacting both departure and arrival options, impacting the cost (since bigger seats may be associated with more expensive tickets), and impacting other factors. The computing system 102 may provide an easy way to understand the pros and cons of the potential change.

In certain embodiments, the AI engines 138 and the machine learning engines 136 may utilize supervised learning, unsupervised learning, and reinforcement learning. In supervised learning, in certain embodiments, a learning set may be processed to identify cost functions based on selected ones of a plurality of available outcomes. The cost function may be related to a mismatch between selected mappings and the data. The computing system 102 may use a mean-squared error to minimize the error between the network's output predicted outputs and the target values over the data set. In certain embodiments, the cost may be minimized using a gradient descent backpropagation algorithm, which can train the AI engines 138 and the machine learning engine 136 to identify purchase options that may be of interest to a particular persona.

In unsupervised learning, in certain embodiments, the computing system 102 may receive some data and a suggested cost function to be determined, which can relate to any aspect of the data. The cost function may be dependent on the task (what outcome the system is trying to achieve) and on a priori assumptions (the implicit properties of a given model, its parameters and the observed variables). The AI engines 138 and the machine learning engines 136 may independently process the data and the suggested cost function to determine a value of the data. The cost function can be related to the posterior probability of the model given the data.

In reinforcement learning, in certain embodiments, the data may be determined dynamically in response to a request or in response to the user's interactions with the environment. At each point in time (T), the AI engines 138 may perform an action (f(T)), and the machine learning engines 136 may generate an observation (y(T)). The AI engines 138, for example, may search and retrieve potential outcomes and determine an instantaneous cost function (c(T)) for each potential outcome. The AI engines 138 may selectively prioritize the potential outcomes based on the cost function unique to selected ones of the one or more personas. In certain embodiments, the decision-making process performed by the AI engines 138 and the machine learning engines 136 may be modeled as Markov decision processes including states {s₀, . . . , sₙ} and actions {a₁, . . . , aₘ} having the following probability distributions: the instantaneous cost distribution P(c_t|s_t), the observation distribution P(X_{T}|S_{T}) and the transition P(S{t+1}|S_{T}, A_{T}), while a policy is defined as the conditional distribution over actions given the observations. In certain embodiments, the observation distribution and the transition may define a Markov chain that can be used to evaluate the cost of the various potential outcomes.

In certain embodiments, the AI engines 138 and the machine learning engines 136 may learn from an initial set of data (structured learning) and then may learn from unknown data sets (unstructured and reinforcement learning). Further, the AI engines 138 and the machine learning engines 136 may strive to provide enhanced searches to improve on the data requested by the user. Further, even after a purchase event, the computing system 102 may be configured to continuously search for “better” options that may have a greater value for the user. In certain embodiments, the machine learning engines 136 may mine collective information, normalized inventory data, private inventory, or take into account the industry's yield management rules, and may cooperate with the AI engines 138 to send queries to suppliers to attempt to uncover other potential searches or outcomes that might be “better” than that selected by the user. In certain embodiments, the user system 102 may process each potential outcome into parameter segments, assuming that each segment may be independently selectable, to produce decision trees from which the potential outcomes may be selected. In certain embodiments, the user may initiate a search that yields certain outcomes. The user may then interact with one or more selectable elements within the interface to change attributes or variables to view new outcomes without restarting the search.

In certain embodiments, the purchase option system 124 may enable a search-in-search functionality, which may allow a user to interact with the settings of an initial search to alter the displayed results and without initiating a new search. In a particular embodiment, the purchase option system may identify a plurality of outcomes based on the user's initial search. The plurality of outcomes may include a snapshot of available inventory at the time of the search. The user may then interact with one or more selectable elements within the interface to change attributes or variables to view new outcomes without restarting the search, because the system may identify the new outcomes from the snapshot that was captured during the initial search. In the context of travel, the user may change a destination city and the results corresponding to the destination city may be displayed without conducting a new search. It should be appreciated that the “destination city” attribute is just one of many possible attributes that could be changed or added by the user. For example, the user could change almost anything, including the destination arrival time range, airline, price, seat size, class, another parameter, or any combination of parameters simultaneously. Other embodiments are also possible.

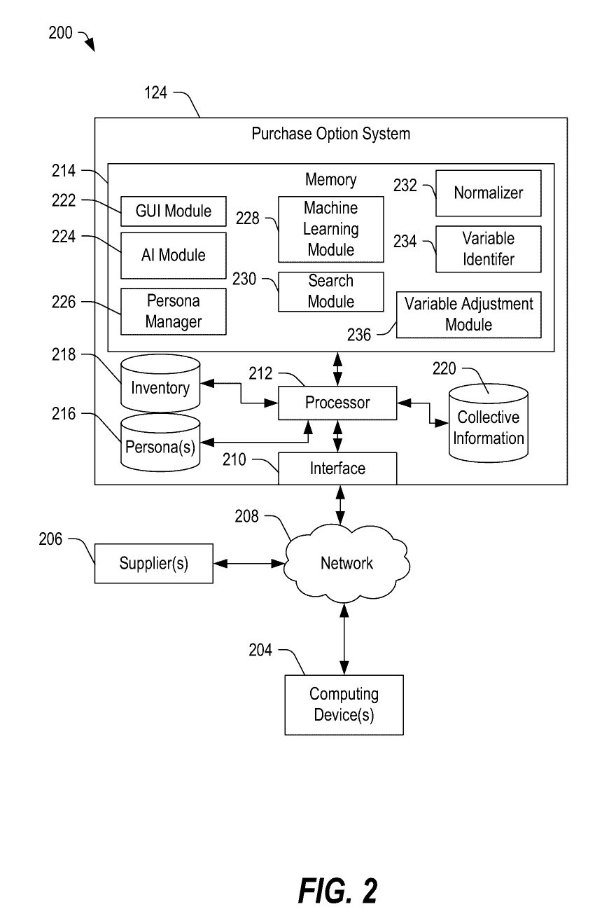

FIG. 2 is a block diagram of a system 200 including a purchase option system 124, in accordance with certain embodiments of the present disclosure. The system 200 may include one or more computing devices 204 and one or more suppliers 206, both of which may be coupled to the purchase option system 124 through a network 208, such as the Internet.

The purchase option system 124 may include an interface 210 configured to communicate data to and receive data from the network 204. The purchase option system 124 may also include a processor 212 coupled to the interface 210. The processor 212 may also be coupled to a memory 214, a database including one or more personas 216, a database including inventory data 218, and a database including collective information 220. The collective information 220 may include search logic, decision-making, outcomes, and other information derived from other users of the purchase option system 124 over time. The inventory data 218 may be normalized data that was previously retrieved from various supplier sites, extracted, transformed, and loaded in the database in a pre-defined data structure suitable for further processing by the processor 212.

The memory 214 may include a graphical user interface (GUI) module 222 that, when executed, may provide an interface to a device for receiving data, for providing information, for receiving selections, or any combination thereof. In some embodiments, the interface may be a graphical interface, such as a web page, which can be rendered and displayed by a computing device, such as one of the computing devices 204. Further, in particular embodiments, the graphical interface may include user-selectable options, such as buttons, pull-down menus, and other user-selectable elements.

In some embodiments, the memory 214 may include an artificial intelligence (AI) module 224 that, when executed, may cause the processor 212 to determine outcomes for a consumer in response to data received from the GUI or from other processes or applications. The AI module 224 may be configured using one or more personas 216, each of which may correspond to a particular entity at a point in time. The memory 214 may further include a persona manager module 226 that, when executed, may cause the processor 212 to select one or more of the personas from the personas database 216 and to configure the AI module 224 with the selected personas. The configured AI modules 224 may identify and prioritize outcomes based on the selected personas.

In some embodiments, the memory 214 may also include a machine learning module 228 that, when executed, may cause the processor 212 to learn from interactions between the system 124 and other computing systems, between the system 124 and suppliers 206, and between the system 124 and users or user devices. The machine learning module 228 may cause the processor 212 to make recommendations, to suggest alternative outcomes, and to assist the consumer in his or her decision-making.

In certain embodiments, the memory 214 may include a search module 230 that, when executed, may cause the processor 212 to perform searches in response to received data. The received data may include a query from a device, a user, a process, or any combination thereof. In some embodiments, the data may include date, departure, destination, or other travel-related information, other information, or any combination thereof. In some embodiments, the received data may be received from the machine learning module 228, from the AI module 224, from another module, or any combination thereof. The search module 230 may be configured to search in response to a request, and optionally to search continuously to find “better” outcomes. In certain embodiments, the continuous search option may be configured by a user as an optional feature.

In certain embodiments, the memory 214 may include a normalizer module 232 that, when executed, may cause the processor 212 to process received data into a format that is standardized for the purchase option system 124. Further, the normalizer module 232 may process queries into one or more formats suitable for searching various data sources to retrieve information. Additionally, in some embodiments, the normalizer module 232 may further process data from retrieved results (such as travel options, outcomes, and so on), in the format that is standardized for the purchase option system 124 for further processing. In some embodiments, the purchase option system 124 may receive inventory information from various suppliers, which inventory information may be processed by the normalizer 232. The normalizer 232 may process the information by extracting, transforming, and loading the data into a pre-defined data structure, which may be stored in inventory database 218.

In certain embodiments, the memory 214 may include a variable identifier 234 that, when executed, may cause the processor 212 to generate a variable object representing each variable within a potential outcome. The variable identifier 234 may cause the processor 212 to process each potential outcome into a decision tree and to label each possible variation as a variable that may be changed by the user.

In certain embodiments, the memory 214 may further include a purchase option variable adjustment module 236 that, when executed, may cause the processor 212 to receive data corresponding to a selectable element associated with the interface. The purchase option variable adjustment module 236 may cause the processor 212 to process the data to determine a change, to process a snapshot of the available inventory to identify purchase options corresponding to the change, and to provide data related to the identified purchase options to the graphical interface. In some embodiments, the purchase option variable adjustment module 236 may cause the processor 212 to determine how a particular change to an attribute may impact the purchase options available to the user. Further, in some embodiments, the AI module 224 may cause the purchase option variable adjustment module 236 to manipulate one or more of the variables to determine a “better” or “alternative” option to suggest a better variable combination that may lead to better outcomes for the user.

In the context of travel, the purchase option variable adjustment module 236 may cause the processor 212 to determine how a particular change impacts the potential travel inventories, and to provide potential outcomes (different itineraries) that correspond to the change. In certain embodiments, the change may include adding a stop to a non-stop trip or to a multi-stop trip. In certain embodiments, the change may include adjusting a departure date, changing a destination airport, adjusting times, changing the price, changing a seat size, changing the class, and so on. The purchase option variable adjustment module 236 may determine how such changes may impact other segments of the itinerary, and may selectively recommend or identify other potential options in lieu of one or more adjacent segments of the itinerary to make each flight segment work with the next.

In certain embodiments, rather than conducting a plurality of separate searches (such as 50 separate searches with different parameters), the purchase option system 124 provides a graphical interface (e.g., a web page or application interface) through which a user may change any combination of variables to find a “better outcome.” For example, again in the context of travel, a flight from Houston, Tex. to London, England from the 3^{rd} through the 10^{th} may be the “best” flight option in a search. However, a flight from Raleigh-Durham, N.C. to London, England departing on the 4^{th} in business class may be even better due to a special (e.g., price discount, frequent flyer rewards, another parameter, or any combination thereof). The purchase option system 124 makes it possible to save potential outcomes and compare outcomes based on any number of different choices. In some embodiments, the user may save a potential outcome arising from a change in one or more of the variables.

In certain embodiments, the purchase option system 124 may monitor the user's variable changes and searches and may make recommendations. In addition to presenting data related to the potential outcomes, the purchase option system 124 may include one or more recommendations. In an example, the purchase option system 124 may determine that the user may be looking for an international flight for vacation purposes, and the purchase option system 124 may identify flights that are popular with others due to an event or something else, and may display the option as a possible recommendation, such as a flight from Dallas, Tex. to London, England to Hong Kong from the 11^{th} through the 21^{st} or a flight from Houston, Tex. to London, England, to Singapore from the 17^{th} through the 28^{th} (premium economy). The recommendation may be based on price, destination, or some other factor determined from the user's search, the user's variable changes, or other factors.

The purchase option system 124 provides an interface through which the user may experiment with any combination of variables to find a “best” outcome. In some embodiments, the purchase option system 124 may carry out some of the same experiments as the user (using the AI module 224 of alter the variables via the variable adjustment module) in the background. Further, the purchase option system 124 may benefit from searches performed by other users and may learn from purchase options identified by other users via their searches and attribute adjustments. In certain embodiments, it may be best for the user to travel from Houston to Hong Kong and then to fly to Singapore for price or other reasons. The user can also avoid airports and places that he or she dislikes (e.g., Paris airport). Further, the user can make adjustments to selected variables to see how the selected options alter the potential outcomes (improved or not). In certain embodiments, the user may be willing to pay a higher price to avoid an airport or an area that he or she dislikes or for a seat in which he or she can sit comfortably (i.e., a wider seat, a seat with greater leg room, etc. In certain embodiments, the user may interact with the interface to save any selected option or options to a clipboard, checkout basket, or other storage container. The user may review saved potential options on the clipboard to compare the various potential options. The user may also indicate that he or she “likes” or “dislikes” any particular potential outcome. Other embodiments are also possible. In a particular example, the AI module 224 may cause the processor to evaluate saved options relative to one another and to provide recommendations between saved “clipboard” options.

In general, the above-discussion uses travel and travel-related search options for illustrative purposes, because such options are easy for most readers to recognize and understand, particularly because most travel search systems provide extremely limited search capabilities. However, the purchase option system 124 is not limited to travel via airlines, and is not limited to the travel industry. In certain embodiments, the purchase option system 124 may be configured to identify travel options that may involve different modes of travel (i.e., train, boat, car, cruise, hiking, gondola, or other modes of travel), and may link such variable modes into a travel itinerary as a potential outcome. Further, in certain embodiments, the purchase option system 124 may allow a user to change departure and arrival cities, times, dates, and so on to expand the travel options. It should be appreciated that the change may be related to any attribute that can be determined from the supplier's information, including departure and arrival cities/airports, departure and arrival times, departure and arrival dates, class, airline, price, and other attributes, including non-standard attributes, such as leg room, seat width, safety rating, age of the plane, type of plane, and so on. The purchase option system 124 may expand the potential outcomes based on interactions with the selectable options via the interface. Outside of travel, the purchase option system 124 may be configured to identify and sort a plurality of purchase options that may be of interest to a user. The purchase option system 124 may provide an interface including data related to one or more of the purchase options and one or more user-selectable elements accessible by a user to configure search attributes. The purchase option system 124 may select others of the plurality of purchase options based on a configuration of one of the search attributes (via the user-selectable elements) and may provide the other purchase options to the graphical interface. Other embodiments are also possible.

While the above-discussion has focused on product purchases, it should be appreciated that the search-in-search capability provided by the purchase option system 124 may be extended to information. The user may conduct an initial search, which may identify a snapshot of available information from which a plurality of information attributes may be determined. The user may then interact with user-selectable options to access such information attributes dynamically to alter the information presented. In some instances, the AI modules 224 may selectively recommend adjustments that may provide better or best results for the user.

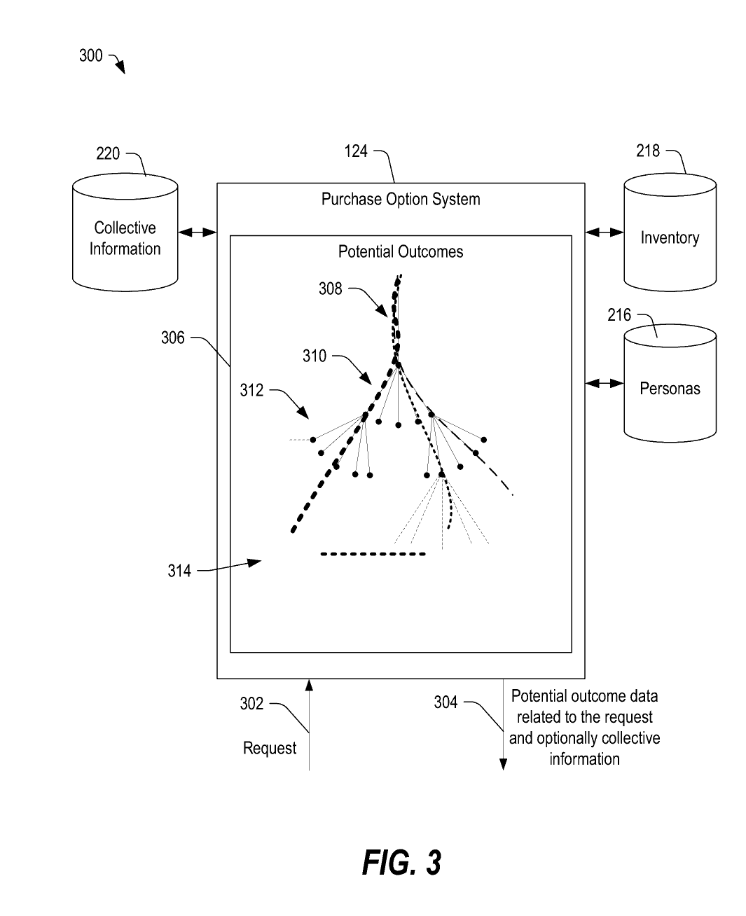

In a travel embodiment, to determine travel segments that may satisfy a consumer's desired travel experience, the purchase option system 124 may work backwards from a destination to identify possible travel segments, and to process the travel segments into decision trees from which variables may be selected. An example of a decision tree representing potential outcomes from the purchase option system 124 is described below with respect to FIG. 3.

FIG. 3 is a conceptual diagram 300 of a mapping of a plurality of outcomes determined by a purchase option system 124 in FIG. 1 or 2, in accordance with certain embodiments of the present disclosure. The purchase option system 124 may receive a request 302 from a source, such as a computing device 204 via a network 208 (in FIG. 2). The request 302 may include one or more parameters, which might be used for a search. In the context of travel, the one or more parameters may include a departure city, a destination, and a date, for example. In the context of vehicles, the one or more parameters may include a new/used parameter, a mileage parameter, a cost parameter, a manufacturer parameter, a year parameters, and so on. The purchase option system 124 may query the inventory 218 based on the request 302, using AI engines configured with one or more selected personas from a personas database 216. Further, the purchase option system 124 may process the request 302 based on the collective information 220 and may retrieve further information from a user based on searches and associated information determined from the collective information 220.

The purchase option system 124 may process the results retrieved from the inventory 218 and from suppliers 206 to determine a plurality of potential outcomes 306. Each of the potential outcomes 306 may be segmented into a plurality of parameters (or attributes), which parameters may be conceptually linked to form a series of branches (decision tree). In the illustrated example, the potential outcomes 306 may include a first parameter (or variable) 308, a second parameter 310, a third parameter 312, and a plurality of additional parameters 314. For example, the parameters may represent variables corresponding to segments of a travel itinerary (e.g., departure city, arrival city, dates, times, costs, etc.). In certain embodiments, the parameters may include different options on the same flight, such as first class versus coach class. In other contexts, the parameters can represent variables determined from the plurality of purchase options for that particular context (e.g., automobiles, books, restaurants, hotels, rental properties, homes for sale, electronic devices, or other products). Other parameters are also possible.

In some embodiments, the parameters 308, 310, 312, and 314 may be organized by the purchase option system 124 into a linked list or linked tree having a hierarchy representing the relative importance of each of the parameters to a particular user. For example, in some embodiments, the purchase option system 124 may process the parameters of each potential outcome into an ordered tree (linked tree), which may have a first parameter 308 corresponding to a travel option arriving at a destination. Other parameters, such as timing, cost, passenger class, and so on, may have varying levels of importance for the particular user. Further, each attribute (whether or not the attribute is accessible to a user) may be added to the linked tree and related to other nodes or branches on the tree. A linked tree may be established for each purchase option, such that a plurality of search options may be represented by a forest of linked trees.

Each potential outcome may be represented by a dashed or dotted line that extends through one or more of the parameters. In an example, the node tree of the parameters of each of the potential outcomes could be organized from the perspective of any of the parameters. Depending on the implementation, the first parameters 308 may be cost, destination, departure city, company name, etc. Any parameter that may be used to form the basis of a decision may be used as a node within the tree. The purchase option system 124 may be configured to generate an interface (such as a web page or other interface) including potential outcome data 304 (such as a list of results and optionally collective information), which interface may be provided to a destination device, such as computing device 204, via the network 208.

In certain embodiments, the purchase option system 124 may be configured to identify a plurality of potential outcomes and to break each of the potential outcomes into its constituent parameters and into individual segments, which allows the purchase option system 124 to produce a potentially optimal outcome from component parts. From a travel itinerary, for example, various flights, interconnections, and other options may be segmented and stitched together to provide a travel outcome that is customized for the user. From a product perspective, color, price, size, model, manufacturer, year, and other information may be segmented and stitched together to provide a product outcome. Travel outcomes, product outcomes, service outcomes, and other outcomes may be referred to as purchase options.

In certain embodiments, the purchase option system 124, as discussed above, may provide an interface including selectable elements configured to allow a user to selectively vary any of the parameters to select different departure or arrival cities, different times, add or remove stops, and so on. It should be appreciated that the change may be related to any attribute that can be determined from the supplier's information, including departure and arrival cities/airports, departure and arrival times, departure and arrival dates, class, airline, price, and other attributes, including non-standard attributes, such as leg room, seat width, safety rating, age of the plane, type of plane, and so on. Such changes may cause the purchase option system 124 to adjust the decision tree 306 or to add additional (parallel) decision trees that link the change information to those aspects of the purchase options that may remain unchanged. Thus, the user may interact with the purchase option system 124 to expand and review various options and changes without having to restart the search. Other options are also possible.

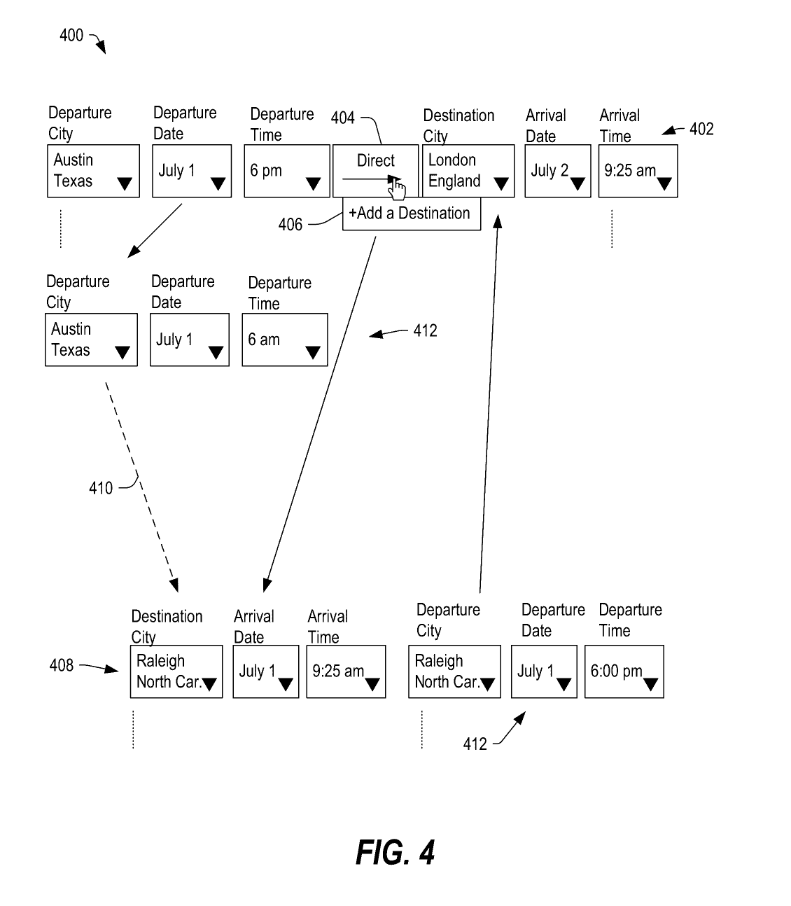

FIG. 4 is a block diagram of an interface 400 of a purchase option system 124 including dynamic itinerary adjustment, in accordance with certain embodiments of the present disclosure. The interface 400 may include a first itinerary 402 showing a direct flight from Austin, Tex. to London England, departing on July 1^{st} at 6 pm and arriving on July 2 at 9:25 am. The first itinerary 402 may include a plurality of selectable elements corresponding to each parameter of the itinerary. In the illustrated example, the selectable elements may be pull-down menu options. However, in certain embodiments, the selectable elements may include wheels, text boxes, check boxes, or other selectable elements. In the illustrated example, the connection block 404 indicates that the flight may be direct, and a pointer is shown that has selected the connection block 404 to expose a menu option 406 (labeled “Add a Destination”). Upon selection of the menu option 406, the interface 400 may allow the user to select an intervening destination city 408 (e.g., an additional stop), which may cause the purchase option system 124 to identify an additional connecting flight 412 (e.g., from the intervening location to the final destination).

The first change to add the intervening destination city 408 may cause the purchase option system 124 to review (at 410) the first segment of the travel itinerary 402 and to propose an alternative segment 412, which may correspond to a flight from Austin, Tex. to Raleigh, N.C. with sufficient time for the user to catch a connecting flight to still arrive in London, England at approximately the scheduled arrival time. In certain embodiments, the intervening destination 408 may cause the initial segment and the final segment of the itinerary to change. In certain embodiments, changes by the user to any of the parameters may result in further changes, having a ripple effect through the available itineraries.

In certain embodiments, the user may hold one segment of the itinerary while playing with variables of other segments. In certain embodiments, the changes may cause the purchase option system 124 to provide a second interface (or a panel within the first interface) so that the user may review the various options in parallel. In certain embodiments, the purchase option system 124 may store the first set of results and the second set of results (corresponding to the change) and may provide a selectable element to allow the user to switch between the potential travel options.

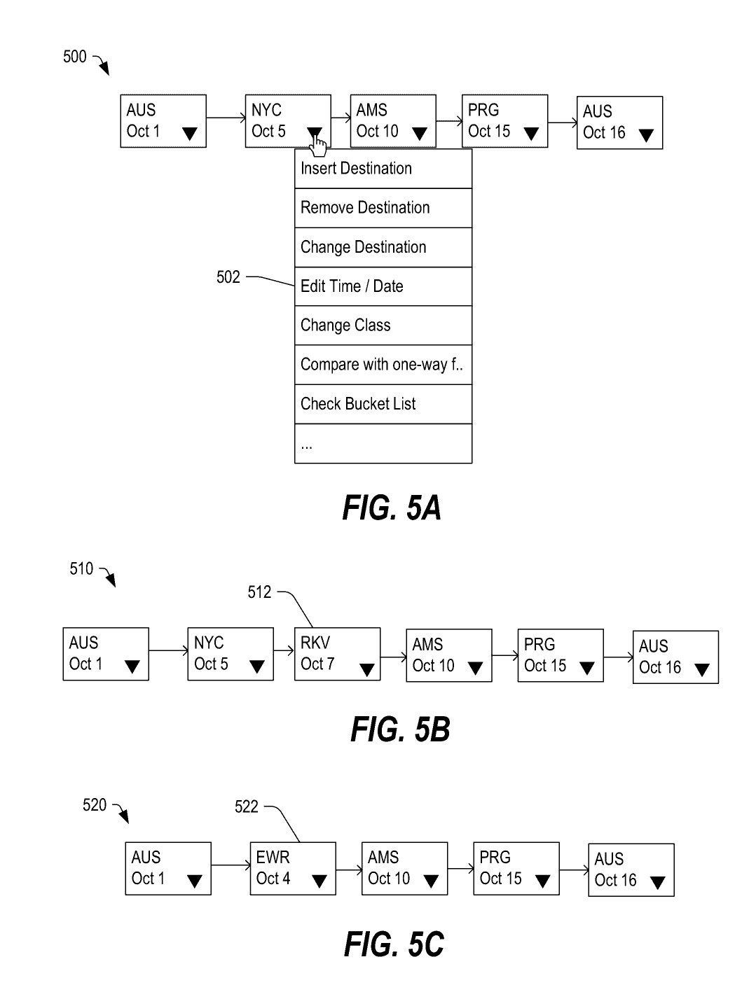

FIGS. 5A-5C are block diagrams of an interface of a purchase option system 124 including dynamic itinerary adjustment, in accordance with certain embodiments of the present disclosure. In FIG. 5A, a summary of an itinerary is shown and generally indicated at 500. The summary 500 may include a first segment from Austin, Tex. to New York City departing on October 1^{st}, a second segment from New York City to Amsterdam departing on October 5^{th}, a third segment from Amsterdam to Prague departing on October 10^{th}, and a fourth segment from Prague to Austin, Tex. departing on October 15^{th} and arriving in Austin on the 16^{th}. Any one of the destinations may be changed, additional destinations may be added, destinations may be removed, and so on. In certain embodiments, the summary 500 may be provided in an interface including multiple selectable elements, such as a pull-down menu 502. The pull-down menu 502 may include a plurality of selectable options, including “Insert Destination”, “Remove Destination”, “Change Destination”, “Edit Time/Date”, “Search for Better”, “Check Bucket List”, other options, or any combination thereof. It should be appreciated that the selectable options accessible via the pull-down menu 502 may be related to any attribute that can be determined from the supplier's information, including departure and arrival cities/airports, departure and arrival times, departure and arrival dates, class, airline, price, and other attributes, including non-standard attributes, such as leg room, seat width, safety rating, age of the plane, type of plane, and so on.

In FIG. 5B, the summary 510 is shown after the user has selected “Insert Destination” from the menu 502 in FIG. 5A. The purchase option system 124 may provide a popup menu or another selectable element to allow the user to identify the additional destination. Once the destination is identified by the user and the departure dates are indicated by the user, the purchase option system 124 may adjust the travel itinerary to insert the additional segments, such as the added destination/departure airport in Reykjavik Iceland indicated at 512. In certain embodiments, the purchase option system 124 may selectively adjust one or more of the adjacent segments to incorporate the change.

In FIG. 5C, the summary 520 is shown after the user has selected “Change Destination” from the menu 502 in FIG. 5A. The purchase option system 124 may provide a popup menu or another selectable element to allow the user to identify the changed destination. Once the destination is identified by the user and the departure dates are indicated by the user, the purchase option system 124 may adjust the travel itinerary to update the segments, such as the change from NYC to Newark, N.J., indicated at 522. In certain embodiments, the purchase option system 124 may selectively adjust one or more of the adjacent segments to incorporate the change. Other embodiments are also possible.

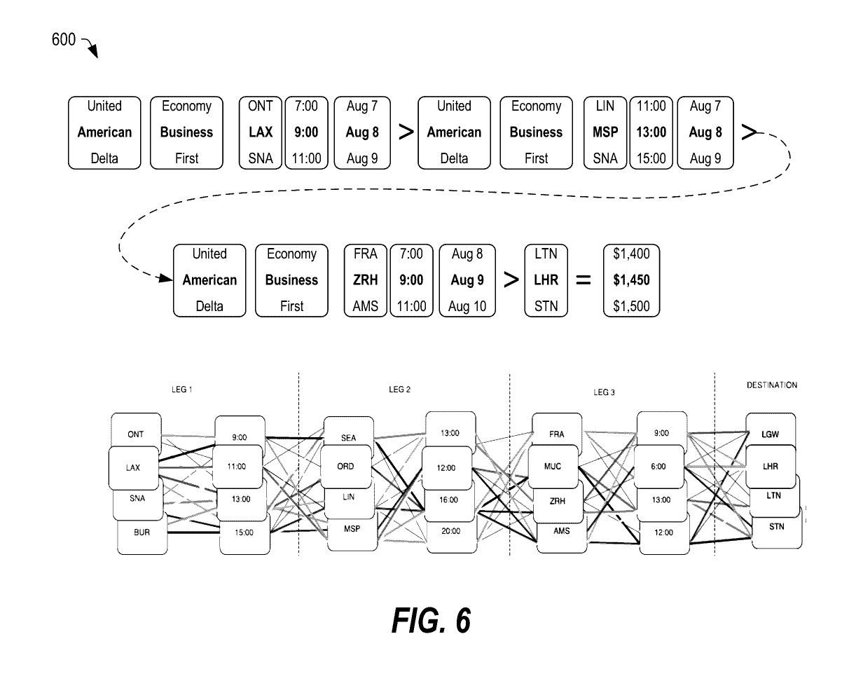

FIG. 6 is a diagram of an interface 600 of a purchase option system 124 including dynamic itinerary adjustment, in accordance with certain embodiments of the present disclosure. The interface 600 generally illustrates dynamic search-in-search functionality of the purchase option system 124, which allows a user to expand result options (potential outcomes) based on multiple variables and variables-from-variables that can extend or expand with each change to a variable.

In the illustrated example, the interface 600 may include a direct trip where the departure time is a primary variable. The direct trip includes a flight from Los Angeles (LAX) to London's Heathrow Airport (LHR) departing at 9:00 am Pacific Standard Time (PST). The flight is priced at $3,400 US.

The interface 600 may also include a multi-stop trip, where each departure time is a variable. The multi-stop trip includes a first segment from LAX to Chicago's O'Hare International airport (ORD) departing at 11:00 am PST, a second segment from ORD to Frankfurt Germany (FRA) departing at 3 pm Central Standard Time (CST), and a third segment from FRA to LHR departing at 11:00 am (in Germany). The flight is priced at $1,300 US.

The interface 600 may further include a multi-stop trip where the departure and arrival cities can be changed along with each subsequent stop and their times. In the illustrated example, the itinerary includes a first segment from LAX to Minneapolis/St. Paul (MSP) departing at 9:00 am PST; a second segment from MSP to Zurich, Switzerland (ZRH) departing at 1 pm CST; a third segment from ZRH to LRH departing at 9:00 am (in Switzerland). The flight is priced at $1,450 US.

In the conceptual diagram below the multi-stop trip, the potential changes for each departure city and time are shown, which changes may have impacts on the arrival city and subsequent departure times for the next flights in the itinerary. The purchase option system 124 may determine the interlocking decision trees for each potential outcome and may adjust the itinerary, as discussed above, based on any changes received from the interface.

In certain embodiments, the interface 600 may include selectable wheels or dials that may allow a user to adjust selected variables. Available options may be provided as part of the selectable element, such that the change can actually be made without having to initiate the search and without having to notify the user that the option is not available. In certain embodiments, the variable identifier 234 in FIG. 2 may identify the potential variable options, which may be used to dynamically generate the selectable element with the potential options included therein. Other embodiments are also possible.

In certain embodiments, the user may interact with the graphical interface 600 to save a selected potential outcome or outcomes (options) to a clipboard, and may selectively adjust one or more of the variables to identify additional potential outcomes. The user may save one or more of the additional potential outcomes to a clipboard. This process may be repeated multiple times, and the user may eventually review the saved outcomes to compare them. In certain embodiments, the user may “like” or “dislike” any of the potential outcomes by clicking on an associated icon or link. Outcomes that the user “dislikes” may be moved to the bottom of the clipboard or may be removed. In certain embodiments, the clipboard may be a popup window, a tab, or a new window within which the potential outcomes may be presented. In some embodiments, the system may also compare the potential outcomes and suggest or make recommendations for the user. Further, the system may automatically manipulate variables for a less experienced user who has no idea of how to achieve better outcomes. The user may purchase a selected outcome (travel itinerary) by selecting the itinerary and authorizing a payment transaction through the purchase option system 124.

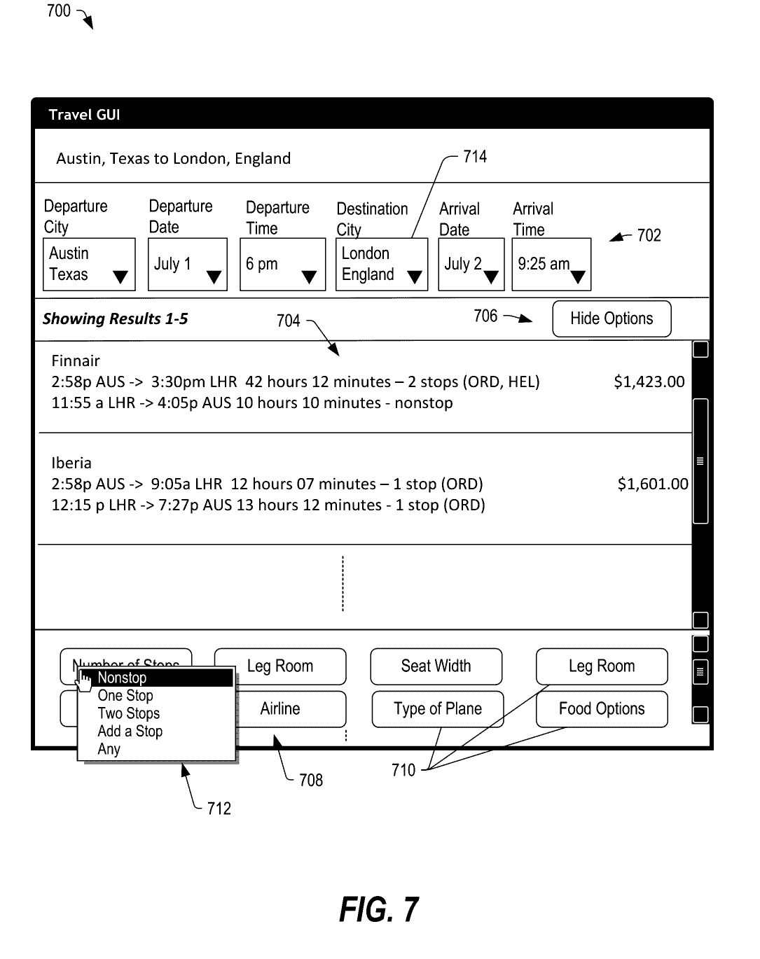

FIG. 7 depicts a graphical interface 700 of potential outcomes provided by a purchase option system, in accordance with certain embodiments of the present disclosure. The graphical interface 700 may include an example of an interface to present potential travel itineraries. The graphical interface 700 includes a plurality of travel itinerary attributes 702, such as a departure city, a departure date, a departure time, a destination city, an arrival date, an arrival time, or other attributes. It should be appreciated that the change may be related to any attribute that can be determined from the supplier's information, including departure and arrival cities/airports, departure and arrival times, departure and arrival dates, class, airline, price, and other attributes, including non-standard attributes, such as leg room, seat width, safety rating, age of the plane, type of plane, and so on.

The graphical interface 700 may also include a results panel 704 that displays one or more results and their associated purchase costs. In this example, a round-trip Finnair airline flight from Austin, Tex. to London Heathrow Airport is shown with two stops on the way there and a non-stop flight on the way back. Further, in this example, a round trip Iberia airline flight is shown with one stop in both directions. Other results may be viewed by scrolling. The ordering or arrangement of the results displayed within the results pane 704 may be determined by the AI engine.

In some embodiments, the graphical interface 700 may include a contextual button or object 706 that may be selected by a user to expose or hide an options panel 708, which may list a plurality of attribute adjustment options. A user may interact with one or more of the attribute adjustment options by selecting one of the selectable options 710 within the options panel 708. In one possible example, the user may right-click on one of the selectable options 710 to expose a menu 712, which allows the user to define restrictions on the search or to add a stop, and so on. Such menu options may vary based on the context of the search and based on the particular option 710.

Further, in some embodiments, the user may interact with one or more user-selectable options 714 corresponding to the travel itinerary attributes 702. The user, for example, may select the destination city attribute selectable option 714 and may change the destination city. In response, the results displayed in the results panel 704 may be updated without having to conduct a new search by identifying corresponding purchase options within the plurality of purchase options.

While the selectable options 714 are depicted as pull-down menus, other embodiments are also possible. In an example, the selectable option 714 may be implemented as a wheel that the user may cause to rotate to select a different option.

By interacting with the options 710 within the options panel 708, the selected option 710 may be added to the selectable options 714 of the travel itinerary attributes 702. Further, in some embodiments, by right-clicking on one of the selectable options 714, a popup menu may be provided to configure the attribute. Other options are also possible.

In the context of arrival time or cost, the attribute may be configured to provide a range. In the context of departure or arrival dates, the attribute may be configured to enable a range of flexibility, making it possible for the computing system to identify purchase options around a specified date, for example, in order to optimize value for the user. Other embodiments are also possible.

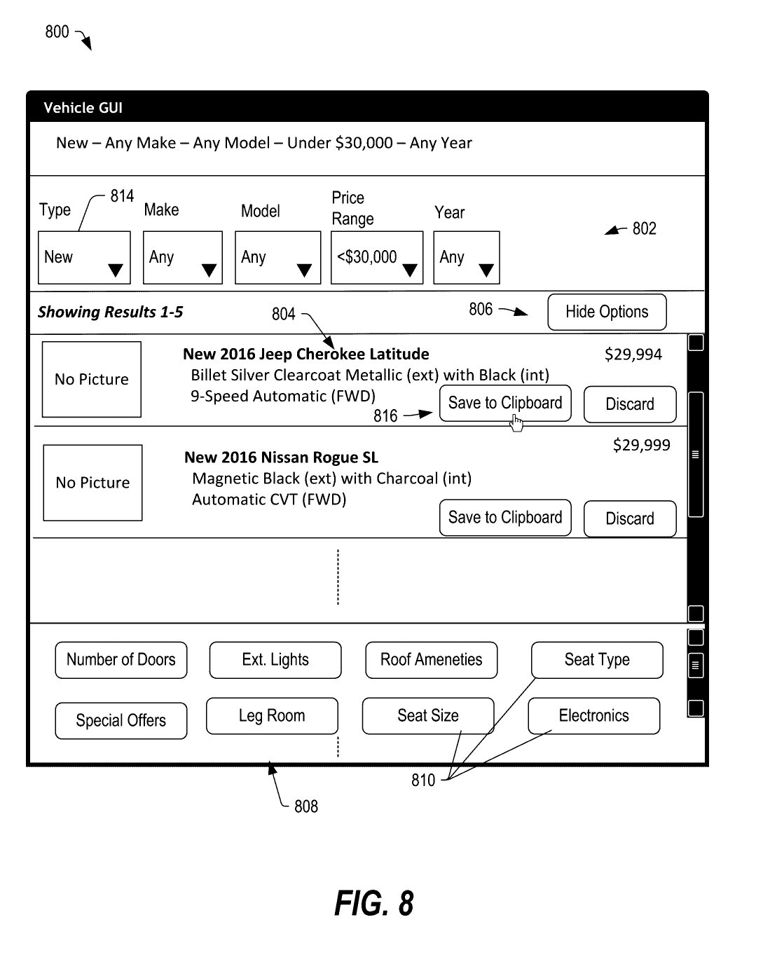

FIG. 8 depicts a second graphical interface 800 of potential outcomes provided by a purchase option system, in accordance with certain embodiments of the present disclosure. In this instance, the graphical interface 800 reflects an automotive search for new vehicles, any make or model, any year, and costing less than $30,000, which resulted in a plurality of purchase options. The graphical interface 800 includes a plurality of automotive purchase attributes 802, including a “New/Used” attribute, a “Make” attribute, a “Model” attribute, a “Price Range” attribute, and a “Year” attribute.

In response to the searches, the graphical interface 800 may include a results panel 804. Within the results panel, the results may include a New 2016 Jeep Cherokee Latitude and a New 2016 Nissan Rogue SL. Other search results may be accessed via the scroll bar.

In some embodiments, the graphical interface 800 may include a contextual button or object 806 that may be selected by a user to expose or hide an options panel 808, which may list a plurality of attribute adjustment options. A user may interact with one or more of the attribute adjustment options by selecting one of the selectable options 810 within the options panel 808. In one possible example, the user may right-click on one of the selectable options 810 to expose a menu, which allows the user to define restrictions on the search, and so on. Such menu options may vary based on the context of the search and based on the particular option 810. Other attributes may also be selected or added to the purchase attributes 802, such as the seat type (Bucket, bench, etc.), the seat size, leg room, and so on. Further, the attributes may include a distance to a dealership, dealership ratings, and so on. Any attribute that can be included in the specifications or descriptions of the particular purchase options may be accessible via one of the selectable options 810. Other embodiments are also possible.

By interacting with the options 810 within the options panel 808, the selected option 810 may be added to the selectable options 814 for the automotive purchase attributes 802. Further, in some embodiments, by right-clicking on one of the selectable options 814, a popup menu may be provided to configure the attribute.

In some embodiments, the user may interact with one or more user-selectable options 814 corresponding to the automotive purchase attributes 802. The user, for example, may select the New/Used attribute selectable option 814 and may change the vehicle type, the color, the mileage, the price, and so on. In response, the results displayed in the results panel 804 may be updated without having to conduct a new search by identify corresponding purchase options within the plurality of purchase options.

Further, each purchase option within the results panel 804 may include a plurality of selectable options 816, such as a “Save to Clipboard” option, a “Discard” option, and other options. In this example, the user may select the “Save to Clipboard” option to save the particular purchase option to a clipboard or other space, so that the user can readily review this option again even after changing some of the attributes and altering the search.

While the selectable options 814 are depicted as pull-down menus, other embodiments are also possible. In an example, the selectable option 814 may be implemented as a wheel that the user may cause to rotate to select a different option. Other options are also possible.

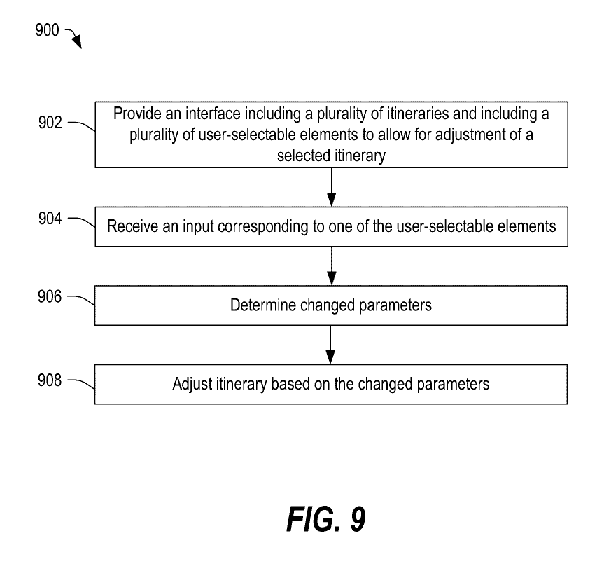

FIG. 9 is a flow diagram of a method 900 of providing dynamic itinerary adjustment, in accordance with certain embodiments of the present disclosure. At 902, the method 900 may include providing an interface including a plurality of itineraries and including a plurality of user-selectable elements to allow for adjustment of a selected itinerary. Each of the plurality of user-selectable elements may correspond to a variable of a particular itinerary to allow the user to selectively alter one, but not all, of the variables to expand the potential outcomes.

At 904, the method 900 may include receiving an input corresponding to one of the user-selectable elements. The input may include data corresponding to a selected one of the user-selectable elements.

At 906, the method 900 may further include determining changed parameters. The changed parameters may include insertion of an intervening destination, deletion of a stop, change of a destination, change of a time/date, initiating a search for a “better” outcome, a “bucket list” option, or other. It should be appreciated that the change may be related to any attribute that can be determined from the supplier's information, including departure and arrival cities/airports, departure and arrival times, departure and arrival dates, class, airline, price, and other attributes, including non-standard attributes, such as leg room, seat width, safety rating, age of the plane, type of plane, and so on. In certain embodiments, the purchase option system 124 may maintain a “bucket list” of travel destinations and other outcomes desired by the user. Upon selection of the “bucket list” option, the purchase option system 124 may evaluate unchecked items in the user's bucket list to determine if a change to the travel itinerary could complete a bucket list item without adding to the cost or delaying the trip. Other options are also possible.

At 908, the method 900 may include adjusting the itinerary based on the changed parameters. As previously discussed, the adjustment may include the selected segment as well as adjacent segments. Further, each change may alter the available number of options for the user to consider and potentially adjust, expanding the potential outcomes.

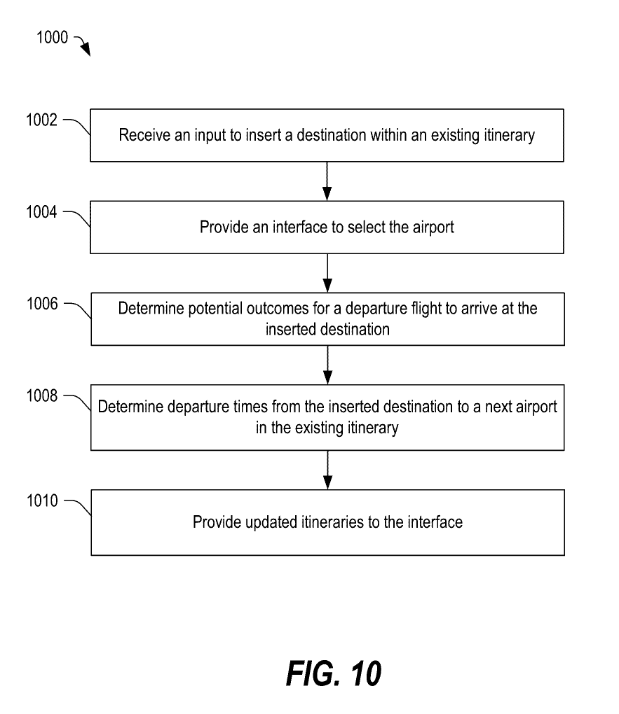

FIG. 10 is a flow diagram of a method 1000 of providing dynamic itinerary adjustment, in accordance with certain embodiments of the present disclosure. At 1002, the method 1000 may include receiving an input to insert a destination within an existing itinerary. The input may include data corresponding to a selected element within an interface provided to a user device, where the interface also includes one or more itineraries and where the input may correspond to a datum within one of the itineraries. In certain embodiments, the input may include a unique identifier corresponding to the itinerary.

At 1004, the method 1000 may include providing an interface to select the airport (for example). In certain embodiments, the interface may allow the user to choose a city first, and then an airport. Other options are also possible.

At 1006, the method 1000 may include determining potential outcomes for a departure flight to arrive at the inserted destination. In certain embodiments, the purchase option system 124 may identify flight segments from the original departure city to the added destination and may identify other departure cities and other potential travel options.

At 1008, the method 1000 may include determining departure times from the inserted destination to a next airport in the existing itinerary. In certain embodiments, there may be no flight from the inserted destination to the previous “next airport” in the existing itinerary, so the purchase option system 124 may search other travel options to reach the traveler's destination.

At 1010, the method 1000 may include providing updated itineraries (potential outcomes) to the interface. In certain embodiments, the method 1000 may also include inserting recommendations and providing advice to the traveler with respect to one or more of the potential outcomes. Other embodiments are also possible.

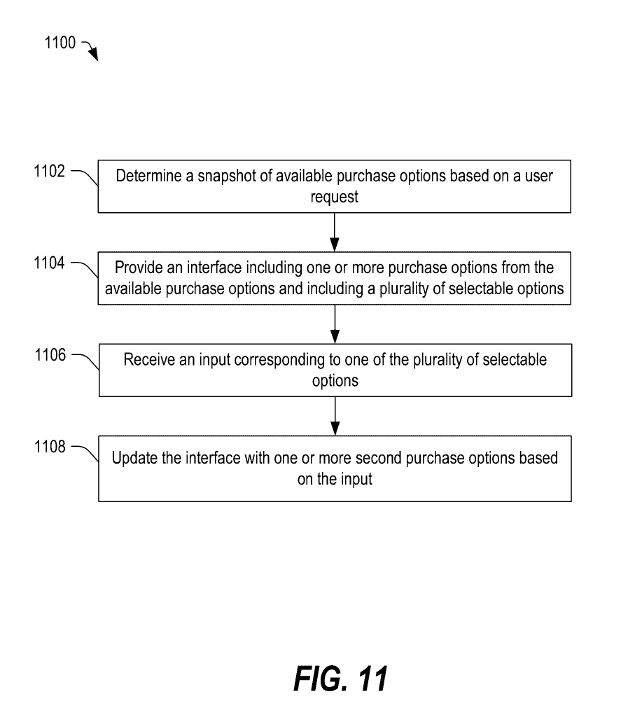

FIG. 11 illustrates a flow diagram of a method 1100 of providing dynamic adjustments, in accordance with certain embodiments of the present disclosure. At 1102, the method 1100 may include determining a snapshot of available purchase options based on a user request. In some embodiments, the user request may include a search, a list of options, or a request in another form.

At 1104, the method 1100 may include providing an interface including one or more purchase options from the available purchase options and including a plurality of selectable options. The selectable options may include pull-down menus, checkboxes, slider bars, wheels, scroller elements, or any combination thereof. Each of the plurality of selectable options may correspond to an attribute of the available purchase options.

At 1106, the method 1100 can include receiving an input corresponding to one of the plurality of selectable options. The input may include adding an attribute option or configuring an existing option. At 1108, the method 1100 can include updating the interface with one or more other purchase options based on the input.

It should be appreciated that the purchase option system 124 may update the interface to include a plurality of purchase options that were not presented initially. In an example, the purchase option system 124 may capture a snapshot of available purchase options, rank the purchase options, and provide selected ones of the purchase options to the user via the interface in response to user selections.

In a particular example, the purchase option system 124 may enable a user to conduct an initial search for a purchase option and then to interact with the user interface to conduct one or more searches within the initial search. To enable the breadth of the adjustment capabilities, the system may capture a snapshot of available purchase options initially. When the user interacts with user-selectable options, the system may identify purchase options within that snapshot based on the user input to identify new options. In a travel-related example, the user may initially search for an airline flight from a first city to a second city. After reviewing some of the options, the user may interact with the interface by scrolling a wheel or adjusting a pull-down menu to change the first city or the second city, and the graphical interface may update the purchase options without the system having to conduct a new search. The system may identify the new purchase options by processing the change against the snapshot of available purchase options captured initially. Other embodiments are also possible.

As discussed above, the example of travel options is easy to describe and easy for the reader to understand, but the systems and methods described above with respect to FIGS. 1-11 are not limited to travel. Other purchase options may also be identified, reviewed, selected, saved, discarded, and so on. Some examples of purchase options may include books, electronic devices, houses, rental properties, hotels, restaurants, automobiles, other products, other services, or any combination thereof.

In conjunction with the systems, methods, and devices described above with respect to FIGS. 1-11, a user may search for potential travel outcomes from a departure city to a destination. Further, the user may interact with selectable elements (wheels, pulldown menus, check boxes, slider bars, and so on) to selectively alter one or more variables of a selected itinerary. The purchase option system 124 may determine changes to the itinerary based on the user's selected change, and may provide one or more adjusted itineraries to an interface for review by the user.

In certain embodiments, a user may adjust one or more variables of a selected itinerary without restarting the search and without impacting other potential itineraries in the list. In certain embodiments, the adjusted itineraries may be displayed in a new window, a new tab, a separate panel, or may otherwise be separately identified relative to the initially identified itineraries. Other options are also possible.

The processes, machines, and manufactures (and improvements thereof) described herein are particularly useful improvements for computers using artificial intelligence based decision systems. Further, the embodiments and examples herein provide improvements in the technology of artificial intelligence based decision systems. In addition, embodiments and examples herein provide improvements to the functioning of a computer by providing enhanced results and dynamic intelligent decisions, thereby creating a specific purpose computer by adding such technology. Thus, the improvements herein provide for technical advantages, such as providing a system in which a user's interaction with a computer system and complex results or decisions are made easier. For example, the systems and processes described herein can be particularly useful to any systems in which a user may want to buy, lease, rent, search, exchange, bid, or barter for goods or services. Further, the improvements herein provide additional technical advantages, such as providing a system in which the personas can operate continuously, apply experiential learning to perform tasks, solve problems, make recommendations, and assist the user by helping manage the user's life experiences to make the user's life easier in terms of dealing with problems, anticipating and solving problems (sometimes before the user is even aware that a problem may exist), managing tasks, and ensuring that all aspects of the user's life receive due attention. While technical fields, descriptions, improvements, and advantages are discussed herein, these are not exhaustive and the embodiments and examples provided herein can apply to other technical fields, can provide further technical advantages, can provide for improvements to other technologies, and can provide other benefits to technology. Further, each of the embodiments and examples may include any one or more improvements, benefits and advantages presented herein.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those skilled in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those skilled in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A purchase option system comprising:
an interface configured to couple to a network;
a processor coupled to the interface; and
a memory coupled to the processor, the memory configured to store instructions that, when executed, cause the processor to:
provide a graphical interface to a destination device via the interface, the graphical interface including at least one purchase option of a plurality of purchase options and including a plurality of selectable options corresponding to each adjustable variable within the plurality of purchase options;
receive data corresponding to selection of one of the plurality of selectable options; and
provide an update to the graphical interface to include at least one different purchase option based on the received data.

2. The purchase option system of claim 1, wherein the memory further includes instructions that, when executed, cause the processor to:
search one or more data sources to retrieve a plurality of purchase options based on a user request; and
determine the at least one purchase option from the plurality of purchase options based in part on the user request and based in part on a ranking of the plurality of purchase options determined by an artificial intelligence engine.

3. The purchase option system of claim 2, wherein the memory further includes instructions that, when executed, cause the processor to:
determine the at least one different purchase option from the plurality of purchase options in response to receiving the data and without performing a second search; and
provide the at least one different purchase option to the graphical interface.

4. The purchase option system of claim 3, wherein the plurality of purchase options includes a first travel product; and
wherein the memory further includes instructions that, when executed, cause the processor to:
determine a second travel product having a parameter corresponding to the received data corresponding to selection of one of the plurality of selectable options; and
provide an update to the graphical interface including the second travel product.

5. The purchase option system of claim 1, wherein the plurality of purchase options include airline flight options and wherein the received data comprises at least one of a seat size parameter, a leg room parameter, and a safety record.

6. The purchase option system of claim 1, wherein the memory further includes instructions that, when executed, cause the processor to recommend a change to a user selectable option, the user selectable option corresponding to an attribute determined from data extracted from the plurality of purchase options.

7. The purchase option system of claim 1, wherein the graphical interface provides at least one of a checkbox, a pulldown menu, and a wheel to enable selection of the plurality of selectable options.

8. A method comprising:
providing a graphical interface to a destination device through a network, the graphical interface including one or more purchase options of a plurality of purchase options from a plurality of data sources, the graphical interface including a plurality of selectable elements, each selectable element corresponding to a variable associated with the plurality of purchase options;
receiving data corresponding to selection of one of the at least one selectable elements;
determining one or more different purchase options from the plurality of purchase options without initiating a new search in response to receiving the data; and
providing the one or more different purchase options to the graphical interface.

9. The method of claim 8, further comprising:
receiving an input corresponding to one or more purchase options of the plurality of purchase options; and
storing data related to the one or more purchase options to a clipboard in response to receiving the input.

10. The method of claim 9, further comprising automatically processing the stored data to determine a recommendation for each of the one or more purchase options.

11. The method of claim 10, further comprising:
automatically determining attributes of the stored data using an artificial intelligence engine;
automatically modify one or more variables to determine one or more additional purchase options corresponding to the determined attributes of the stored data; and
automatically provide the one or more additional purchase options to the graphical interface as recommendations.

12. The method of claim 8, further comprising:
searching a plurality of data sources to retrieve the plurality of purchase options based on a user request;
storing the plurality of purchase options; and
determining the one or more purchase options and the one or more different purchase options from the plurality of purchase options.

13. The method of claim 8, wherein receiving the data comprises receiving an input corresponding to a variable of the plurality of purchase options.

14. The method of claim 8, wherein the plurality of purchase options include airline flight options and wherein the received data comprises at least one of a seat size parameter and a leg room parameter.

15. The method of claim 8, wherein the plurality of purchase options include vehicle options and wherein the received data includes a selection corresponding to an attribute of a plurality of vehicles.

16. The method of claim 8, wherein the graphical interface provides at least one of a checkbox, a pulldown menu, and a wheel to enable selection of the plurality of selectable options.

17. A purchase option system comprising:
an interface configured to couple to a network;
a processor coupled to the interface; and
a memory coupled to the processor, the memory configured to store instructions that, when executed, cause the processor to:
receive data corresponding to a user request;
provide a graphical interface to a destination device via the interface, the graphical interface including a first set of purchase options of a plurality of purchase options corresponding to the user request and including a plurality of selectable options, each selectable option corresponding to an attribute of the plurality of purchase options;
receive data corresponding to selection of one of the plurality of selectable options; and
provide an update to the graphical interface to include at least one different purchase option based on the received data.

18. The purchase option system of claim 17, wherein the memory further includes instructions that, when executed, causes the processor to:
parse the user request to determine parameters corresponding to a plurality of attributes; and
retrieve the plurality of purchase options based on the plurality of attributes.

19. The purchase option of claim 18, wherein the memory further includes instructions that, when executed, causes the processor to:
change at least one of the parameters corresponding to the plurality of attributes; and
determine the at least one different purchase option based on the change to the parameters.

20. The purchase option of claim 17, wherein the memory further includes instructions that, when executed, cause the processor to:
receive an input corresponding to a selection of one or more purchase options of the set of purchase options; and
save the one or more purchase options to a clipboard in response to receiving the input.
